(19) United States
(12) Patent Application Publication
(10) Pub. No.: US 2016/0121463 A1
(43) Pub. Date: May 5, 2016

(54) DRIVE SOCKET

(71) Applicants: Raymond Steven Troy, Chicago, IL (US); Fredinand Henry VandeVoorde, Fountain, MI (US); Daniel Shane Vande Voorde, Ashland, MO (US); Clinton Farrell Matthews, Columbia, MO (US)

(72) Inventors: Raymond Steven Troy, Chicago, IL (US); Fredinand Henry VandeVoorde, Fountain, MI (US); Daniel Shane Vande Voorde, Ashland, MO (US); Clinton Farrell Matthews, Columbia, MO (US)

(21) Appl. No.: 14/530,684

(22) Filed: Oct. 31, 2014

(51) Int. Cl. B25B 13/10

(52) U.S. Cl. CPC B25B 13/102

(57) ABSTRACT

A drive socket comprises a main body, and an adaptor. The main body includes an internal service defining a first cavity configured to receive a head of a first fastener having a first drive size. The adaptor is positioned in the first cavity and includes an internal surface defining a second cavity configured to receive a head of a second fastener having a second drive size. The adaptor is configured to be shifted between first and second positions depending on the drive size of the fastener being tightened of untightened.

### BACKGROUND

Embodiments of the present invention generally relate to a drive socket.

Drive sockets come in many sizes and shapes for tightening and untightening fasteners of different sizes and shapes. A conventional socket set comes with a number of standard size drive sockets so that a user can fasten and unfasten any standard size fastener he will likely encounter. Conventional socket sets thus are heavy and expensive. A user attempting to determine the drive size of a fastener often estimates the drive size, selects the corresponding drive socket, and attempts to position the drive socket onto the fastener. If the drive socket is the incorrect size, the user must choose another drive socket until he finds the correct one. This can be tedious and time consuming especially when the user is working on a car or in difficult to reach places and the socket set is not within reach.

### SUMMARY

A drive socket constructed in accordance with embodiments of the present invention is illustrated. The drive socket broadly comprises a main body, an adaptor, a pin, and a biasing element. The main body includes an interior surface defining a first cavity for holding the adaptor and biasing element therein. The interior surface is also shaped to fit at least a portion of a head of a first fastener into the first cavity. The adaptor includes an outer surface with a shape similar to the interior surface of the main body for rotationally coupling the adaptor to the main body. The adaptor also includes an interior surface defining a second cavity to fit at least a portion of a head of a second fastener having a drive size different than the drive size of the first fastener into the second cavity. The pin retains the adaptor in the first cavity of the main body. The adaptor is configured to shift between first and second positions in the first cavity of the main body depending on the fastener being inserted into the drive socket. The biasing element biases the adaptor to the first position.

This summary is provided to introduce a selection of concepts in a simplified form that are further described in the detailed description below. The summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective exploded view of a drive socket constructed in accordance with an embodiment of the present invention;

FIG. 2 is an elevation view of the drive socket of FIG. 1 with the adaptor in a first position;

FIG. 3 is an elevation view of the drive socket of FIG. 1 with the adaptor in a second position;

FIG. 4 is a perspective view of a drive socket with a proximal cavity; and

FIG. 5 is a perspective view of a drive socket with a handle.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

Turning now to the drawing figures, a drive socket 10 constructed in accordance with an embodiment of the invention is illustrated. The drive socket 10 includes a main body 12, an adaptor 14, a pin 16, and a biasing element 18.

The main body 12 receives a turning torque and exerts a turning torque onto a first fastener or the adaptor 14 as described below. The main body may be formed of steel or any other suitable material. The main body 12 includes an internal surface 20 and a pin hole 22. The internal surface 20 defines a first cavity 24 and includes a plurality of adjacently positioned subsurfaces 26 forming a first polygonal shape such as a hexagon, square, star, Phillips driver, flat driver, or other fastener head shape. In one embodiment, the polygonal shape is a 5/16^{th} inch hexagon for receiving a hexagon head fastener having a 5/16^{th} inch drive size. The first cavity 24 opens towards a distal end of the main body 12 and receives the adaptor 14 and the biasing element 18 therein. The first cavity 24 may be 0.5 inches to 5 inches long for removing nuts from long bolts and performing similar tasks. The pin hole 22 is configured to receive the pin 16 therethrough as described below.

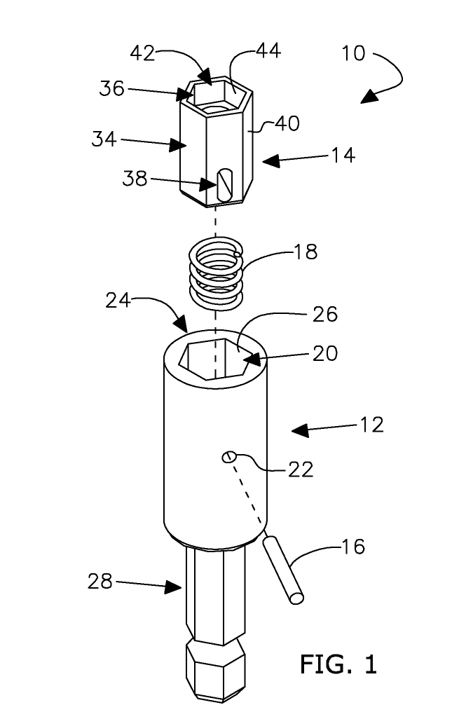

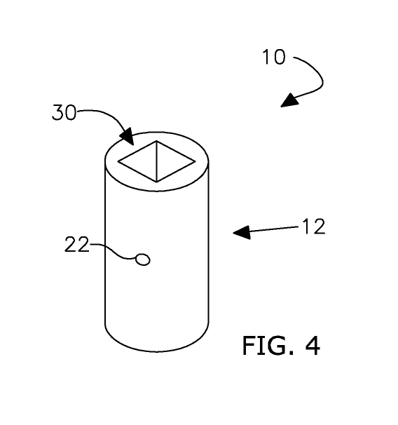

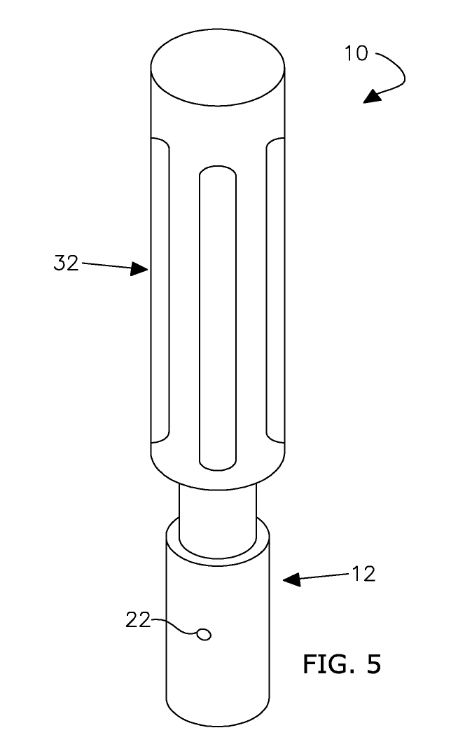

The main body 12 may also include a stem 28 extending from a proximal end of the main body 12 (FIGS. 1-3), a proximal cavity 30 extending into a proximal end of the main body 12 (FIG. 4), or a handle 32 extending from the main body 12 (FIG. 5) for receiving a turning torque. For example, the stem 28 may be a hexagonal shaped member for being inserted into a chuck of a drill and receiving a turning torque therefrom. The proximal cavity 30 may receive an extension shaft or a drive shaft of a socket wrench for receiving a turning torque therefrom. In one embodiment the proximal cavity is a square shaped cavity. The handle 32 may be shaped for providing a user a firm grip for exerting a turning torque on the main body 12.

The adaptor 14 exerts a turning torque onto a second fastener having a different driver size than the first fastener. The adaptor 14 may be formed of steel or any other suitable material. The adaptor 14 includes an external surface 34, an internal surface 36, and a pin slot 38. The external surface 34 includes a plurality of adjacently positioned subsurfaces 40 forming a second polygonal shape similar to and slightly smaller than the first polygonal shape for allowing the adaptor 14 to be slidably positioned in the first cavity 24. The external surface 34 and the internal surface 20 of the main body 12 have a tight tolerance between 0.001 to 0.01 inches depending on the materials of the main body 12 and the adaptor 14 for effectively transferring a torque from the main body 12 to the adaptor 14. In one embodiment, the tolerance may be 0.0025 inches between the main body 12 and the adaptor 14. The internal surface 36 defines a second cavity 42 and includes a plurality of adjacently positioned subsurfaces 44 forming a third polygonal shape similar to the first polygonal shape for receiving a head of the second fastener therein and exerting a turning torque thereon. In one embodiment the third polygonal shape is a ¼^{th} inch hexagon for receiving a hexagon head fastener having a ¼^{th} inch drive size. The pin slot 38 extends into or through a sidewall of the adaptor 14 and aligns with the pin hole 38.

The pin 16 keeps the adaptor in the first cavity 24 of the main body 12 and may be a small cylinder or similar shaped member. The pin 16 may be a compression pin and may be formed of steel or any other suitable material. The pin 16 is positioned in the pin hole 22 and extends into the pin slot 38. In one embodiment the pin 16 is interference fitted in the pin hole 22. The pin 16 may alternatively be welded, screwed or otherwise fixedly positioned in the pin hole 22. The pin may have a diameter between 1/32^{th} inch to ¼^{th} inch.

The biasing element 18 biases the adaptor 14 as described below and may be a coil spring, a leaf spring, a bent tab spring, or any other type of biasing element. In one embodiment the biasing element 18 is positioned in the first cavity 24 behind the adaptor 14.

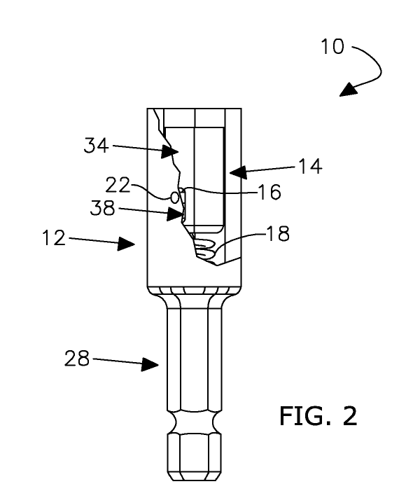

Use of the drive socket 10 will now be described in detail. A user may wish to tighten or untighten a first fastener having a head with a first drive size and drive shape coinciding with a first drive size and drive shape of the drive socket 10 (that is, the head of the first fastener has a polygonal shape that fits snugly with the first polygonal shape of the first cavity 24 of the main body 12). The user may then position the drive socket 10 on the head of the first fastener such that the head of the first fastener is at least partially inserted into the first cavity 24 of the main body 12. The head of the first fastener pushes the adaptor 14 approximately 1/16^{th} of an inch to half of an inch into the first cavity 24 as the user pushes the drive socket 10 onto the head of the first fastener so that the adaptor 14 is in a first position (FIG. 2). In one embodiment the adaptor 14 is pushed ⅛^{th} of an inch into the first cavity 24. The adaptor 14 compresses the biasing element 18 into a compressed configuration in the first position. The user may then exert a turning torque onto the main body 12 of the drive socket 10 via a drill connected to the stem 28, via a drive shaft inserted into the proximal cavity 30 (FIG. 4), or by turning the handle 32 (FIG. 5). The main body 12 will then exert a turning torque onto the head of the first fastener, thus tightening or untightening the second fastener.

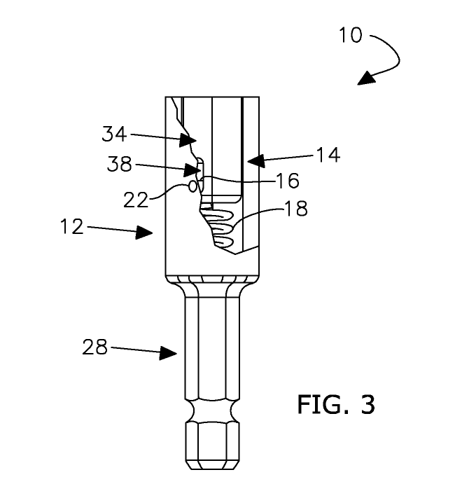

The user may then wish to tighten or untighten a second fastener having a head with a second drive size and drive shape coinciding with a second drive size and drive shape of the drive socket 10 (that is, the head of the second fastener has a polygonal shape that fits snugly with the third polygonal shape of the second cavity 42 of the adaptor 14). With the drive socket 10 removed from the first fastener, the biasing element 18 will push the adaptor 14 to the second position while the pin 16 prevents the adaptor 14 from exiting the first cavity 24 of the main body 12 (FIG. 3). The user may then position the drive socket 10 on the head of the second fastener such that the head of the second fastener is at least partially inserted into the second cavity 42 of the adaptor 14. The user may then exert a turning torque onto the main body 12 of the drive socket 10 via a drill connected to the stem 28, via a drive shaft inserted into the proximal cavity 30 (FIG. 4), or by turning the handle 32 (FIG. 5). The main body 12 will then exert a turning torque onto the adaptor 14 (via the closely-fitting first polygonal shape of the main body and the second polygonal shape of the adaptor 14) and the adaptor 14 will then exert a turning torque onto the second fastener, thus tightening or untightening the second fastener.

The above-described drive socket 10 provides several advantages over conventional drive sockets. For example, the drive socket 10 allows a user to fasten/unfasten two common fastener sizes using only a single drive socket. The drive socket 10 allows a user to try one size of the drive socket on the fastener and then simply shift the adaptor 14 between first and second positions if his first guess is wrong. A socket set made with a number of drive sockets such as the drive socket 10 effectively reduces the number of drive sockets needed by half.

Although the invention has been described with reference to the embodiments illustrated in the attached drawing figures, it is noted that equivalents may be employed and substitutions made herein without departing from the scope of the invention as recited in the claims. Having thus described various embodiments of the invention, what is claimed as new and desired to be protected by Letters Patent includes the following:

1. A drive socket comprising:
a main body having an internal surface defining a first cavity, the internal surface having a plurality of adjacently positioned subsurfaces such that the first cavity defines a first polygonal shape for fitting onto a polygonal-shaped head of a first fastener, the first cavity being open at a distal end of the main body for receiving the head of the first fastener; and
an adaptor having:
an external surface having a plurality of adjacently positioned subsurfaces that define a second polygonal shape for aligning with the first polygonal shape so as to rotationally couple the adaptor to the main body when the adaptor is positioned in the first cavity of the main body;
an internal surface defining a second cavity, the internal surface having a plurality of adjacently positioned subsurfaces such that the second cavity defines a third polygonal shape smaller than the first polygonal shape for fitting onto a polygonal-shaped head of a second fastener having a driver size smaller than the first fastener,
the adaptor being configured to be:
shifted to a first position for positioning at least a portion of the head of the first fastener in the first cavity, the internal surface of the main body being configured to exert a torque on the first fastener when the adaptor is in the first position and the head of the first fastener is positioned in the first cavity; and
shifted to a second position, the internal surface of the adaptor being configured to exert a torque on the second fastener when the adaptor is in the second position and the head of the second fastener is positioned in the second cavity.

2. The drive socket of claim 1, wherein the adaptor is shiftable from approximately one sixteenth of an inch to one inch between the first position and the second position.

3. The drive socket of claim 1, wherein the first and third polygonal shapes are metric sizes.

4. The drive socket of claim 1, wherein the first and third polygonal shapes are imperial sizes.

5. The drive socket of claim 1, wherein the first and third polygonal shapes are selected from the group consisting of hexagon, square, star, Phillips driver, and flat driver.

6. The drive socket of claim 1, wherein the main body further comprises a pin hole extending through a side of the main body into the first cavity, the adaptor further comprises a pin slot extending into a side of the adaptor and configured to align with the pin hole of the main body when the adaptor is inserted into the first cavity of the main body, and the drive socket further comprises a pin configured to be inserted into the pin hole and the pin slot when the adaptor is inserted into the first cavity of the main body for retaining the adaptor in the first cavity of the main body.

7. The drive socket of claim 6, wherein the pin is interference fitted into the pin hole.

8. The drive socket of claim 6, wherein the pin is friction fitted into the pin hole.

9. The drive socket of claim 1, further comprising a biasing element positioned in the first cavity and configured to bias the adaptor toward the second position.

10. The drive socket of claim 9, wherein the biasing element is a coil spring.

11. The drive socket of claim 1, wherein the main body further comprises a stem extending from a proximal end of the main body for receiving a driving torque.

12. The drive socket of claim 11, wherein the stem includes a hexagonal shape for inserting into a chuck of a drill.

13. The drive socket of claim 1, wherein the main body further comprises a handle extending from a proximal end of the main body for receiving a driving torque from a user.

14. The drive socket of claim 1, further comprising a proximal cavity for receiving a member of a driving tool.

15. The drive socket of claim 14, wherein the proximal cavity includes a square shape for receiving a square shaped member configured to exert a torque on the main body.

16. The drive socket of claim 1, wherein the external surface of the adaptor and the internal surface of the main body have a tolerance of between 0.01 and 0.001 inches.

17. The drive socket of claim 1, wherein the main body is configured to receive a fastener having a 5/16^{th} inch drive size.

18. The drive socket of claim 1, wherein the adaptor is configured to receive a fastener having a ¼^{th} inch drive size.

19. A drive socket comprising:
a main body; and
an adaptor rotatable coupled to the main body and shiftably connected to the main body along a longitudinal axis,
the main body being configured to receive a driving torque and exert a driving torque on a first fastener when the adaptor is shifted to a first position, and
the adaptor being configured to exert a driving torque on a second fastener having a different driver size than the first fastener when the adaptor is shifted to a second position.

20. A drive socket comprising:
a main body having:
an internal surface defining a first cavity, the internal surface having a plurality of adjacently positioned subsurfaces such that the first cavity defines a first polygonal shape for fitting onto a polygonal-shaped head of a first fastener, the first cavity being open at a distal end of the main body for receiving the head of the first fastener; and
a pin hole extending through a side of the main body into the first cavity; and
a stem extending from a proximal end of the main body for receiving a driving torque;
an adaptor having:
an external surface having a plurality of adjacently positioned subsurfaces that define a second polygonal shape for aligning with the first polygonal shape so as to rotationally couple the adaptor to the main body when the adaptor is positioned in the first cavity of the main body;
an internal surface defining a second cavity, the internal surface having a plurality of adjacently positioned subsurfaces such that the second cavity defines a third polygonal shape smaller than the first polygonal shape for fitting onto a polygonal-shaped head of a second fastener having a driver size smaller than the first fastener; and
a pin slot extending into a side of the adaptor and configured to align with the pin hole of the main body when the adaptor is inserted into the first cavity of the main body;
a pin configured to be inserted into the pin hole and the pin slot when the adaptor is inserted into the first cavity of the main body for retaining the adaptor in the first cavity of the main body; and
a biasing element positioned in the first cavity,
the adaptor being configured to be:
shifted to a first position for positioning at least a portion of the head of the first fastener in the first cavity, the internal surface of the main body being configured to exert a torque on the first fastener when the adaptor is in the first position and the head of the first fastener is positioned in the first cavity; and
shifted to a second position, the internal surface of the adaptor being configured to exert a torque on the second fastener when the adaptor is in the second position and the head of the second fastener is positioned in the second cavity,
the biasing element being configured to bias the adaptor towards the second position,
the pin and the pin slot cooperatively being configured to allow the adaptor to shift between the first and second positions but not to shift out of the first cavity of the main body.
